(19) United States
(12) Patent Application Publication
(10) Pub. No.: US 2019/0006090 A1
(43) Pub. Date: Jan. 3, 2019

(54) COIL COMPONENT

(71) Applicant: TDK CORPORATION, Tokyo (JP)

(72) Inventors: Masaki KAN, Tokyo (JP); Han WU, Tokyo (JP)

(73) Assignee: TDK CORPORATION, Tokyo (JP)

(21) Appl. No.: 16/021,758

(22) Filed: Jun. 28, 2018

(30) Foreign Application Priority Data
Jun. 29, 2017 (JP) 2017-126899

(51) Int. Cl. H01F 27/32; H01F 27/28; H01F 27/30

(52) U.S. Cl. CPC H01F 27/325; H01F 27/2847; H01F 5/02; H01F 2027/2861; H01F 27/306

(57) ABSTRACT

A coil component includes a non-conductive bobbin and a coil that winds around the bobbin. The coil includes first and second coil members with joining portions in which joining holes are formed. The bobbin includes first and second bobbin members. The first bobbin member includes: first and second positioning portions that position the first and second coil members, respectively, when the first and second coil members are moved onto the first bobbin member; and a support that supports lower portions of the first and second joining portions. The second bobbin member includes a first insulator disposed between the first and second coil members. The first and second coil members and the second bobbin member are attached to the first bobbin member by being moved in a single direction without a further step of rotating.

### FIELD OF THE INVENTION

The present invention relates to a coil component equipped with a bobbin and a coil that winds around the bobbin.

### DESCRIPTION OF THE RELATED ART

A coil component disclosed by the present applicant in Patent Literature 1 (Japanese Patent No. 5,273,192 (See Pages 4 to 9, and FIGS. 7, 8, and 10)) is known as one example of this type of coil component. This coil component includes a coil bobbin, a first coil winding, a second coil winding, and a screw as a connection member. When the coil component is assembled, the rear surface of the first coil winding and one end of the coil bobbin are placed facing one another and then projecting portions provided on the same end of the coil bobbin and notches provided in the first coil winding are aligned. After this, one end of a barrel of the coil bobbin is inserted into an opening provided in the first coil winding. At this time, the projecting portions of the coil bobbin are inserted through the notches of the first coil winding. Next, the first coil winding is rotated relative to the coil bobbin in a state where a flange of the coil bobbin is in contact with a rear surface of the first coil winding. At this time, the projecting portions of the coil bobbin engage the edge of the first coil winding so that the coil bobbin and the first coil winding are fixed in a positioned state. By doing so, the first coil winding is assembled on the coil bobbin. Next, the rear surface of the second coil winding and the other end of the coil bobbin are placed facing one another, and then projecting portions provided at the other end of the coil bobbin and notches provided in the second coil winding are aligned. The other end of the barrel of the coil bobbin is then inserted into an opening of the second coil winding. When doing so, the projecting portions of the coil bobbin are inserted through the notches of the second coil winding. After this, the second coil winding is rotated relative to the coil bobbin in a state where a flange of the coil bobbin is in contact with a rear surface of the second coil winding. At this time, the projecting portions of the coil bobbin engage the edge of the second coil winding so that the coil bobbin and the second coil winding are fixed in a positioned state. By doing so, the second coil winding is assembled on the coil bobbin. Next, a terminal provided on the first coil winding and a terminal provided on the second coil winding are joined by a screw to electrically connect the terminals. By doing so, the coil component is assembled.

### SUMMARY OF THE INVENTION

However, the coil component described above has the following problem to be solved. More specifically, when assembling the coil component described above, it is necessary to insert one end of the barrel of the coil bobbin into the opening in the first coil winding and to insert the other end of the barrel of the coil bobbin into the opening in the second coil winding (that is, to insert the barrel of the coil bobbin from different directions into the respective openings of the coil windings) and to rotate the coil windings with respect to the coil bobbin to fix the coil bobbin and the coil windings in the positioned state, which makes the assembly process complex. Further, since the assembly process (in particular, the step of rotating the coil windings) is complex, it is difficult to automate assembly using robots and therefore difficult to improve the assembly efficiency. Also, when assembling the coil component, a terminal of the first coil winding and a terminal of the second coil winding are connected by a screw. With this configuration, when the screw is tightened, the terminals may become shaved by the screw to produce chips or burrs, and when these chips or burrs fall off onto a circuit board or the like on which the coil component has been incorporated, this can cause electrical shorting.

The present invention was conceived in view of the problem described above and has a principal object of providing a coil component capable of improving assembly efficiency and preventing electrical shorting.

To achieve the stated object, a coil component according to the present invention comprises: a non-conductive bobbin; and a coil that winds around the bobbin, wherein the coil includes: a first coil member with a first main body, which is formed in one of an arc shape and a spiral shape, and a first joint, which is provided at one end of the first main body and in which a first joining hole is formed; and a second coil member with a second main body, which is formed in one of an arc shape and a spiral shape, and a second joint, which is provided at one end of the second main body and in which a second joining hole is formed, wherein the second coil member is electrically connected to the first coil member via a screw that is inserted through the first and second joining holes of the first and second joints, the bobbin includes a first bobbin member and a second bobbin member, the first bobbin member includes: a base plate that has a first opening formed in a central portion thereof; a barrel that is erected on the base plate so as to connect to the first opening; a first positioner that positions the first coil member when the first coil member is moved along a center axis of the barrel from a front end of the barrel toward the base plate; a second positioner that positions the second coil member when the second coil member is moved along the center axis from the front end of the barrel toward the base plate; and a support that is provided on the base plate and is formed so as to surround and support lower portions of the first and second joints of the first and second coil members, the second bobbin member includes a first insulator that is plate-shaped, has a second opening formed in a central portion thereof, and is disposed between the first and second coil members to insulate the first and second coil members from each other, the first coil member is positioned by the first positioner in a state where the barrel is inserted through the first main body and the first coil member is disposed on the base plate, and the first joint is supported by the support, the first insulator is disposed on the first coil member in a state where the barrel has been inserted through the second opening, and the second coil member is positioned by the second positioner in a state where the barrel is inserted through the second main body and the second coil member is disposed on the first insulator, and the second joint is supported by the support.

Also, in the coil component according to the present invention, the second bobbin member includes a second insulator that is plate-shaped and has a third opening in a central portion thereof, and the second insulator is disposed on the second coil member in a state where the barrel has been inserted through the third opening.

Also, in the coil component according to the present invention, the first and second insulators face each other at a distance and are integrated due to parts of edges of the first and second insulators being connected by a side wall.

Also, in the coil component according to the present invention, the second main body is formed in a spiral shape and has two rings that face each other at a distance, and the second bobbin member includes a non-conductive holder that is formed in a flange shape that protrudes from an inner surface of the side wall, is inserted between the rings, and holds the rings in a separated state.

Also, in the coil component according to the present invention, the support functions as the first positioner and the second positioner.

Also, the coil component according to the present invention further comprises: a first core that has a first pillar inserted into a base end side of the barrel; and a second core that has a second pillar inserted into the front end side of the barrel, wherein the first bobbin member includes a third positioner that positions the first core.

Also, in the coil component according to the present invention, the second bobbin member includes a fourth positioner that positions the second core.

Also, in the coil component according to the present invention, the third positioner positions the second core.

With the above coil component according to the present invention, by providing the first bobbin member with the first positioner that positions the first coil member when the first coil member is moved along a center axis of the barrel from the front end of the barrel toward the base plate and the second positioner that positions the second coil member when the second coil member is moved along the center axis from the front end of the barrel toward the base plate, it is possible to position the respective coil members with respect to the first bobbin member by merely moving the coil members in a single direction (i.e., from the front end of the barrel toward the base plate). This means that according to the above coil component, compared to a conventional configuration that inserts the barrel of the coil bobbin into the two coil windings from different directions and positions the coil bobbin and the respective coil windings by rotating the coil windings with respect to the coil bobbin, it is possible to sufficiently simplify the assembly process. Since the assembly process is simplified, it is possible to automate the assembly using a robot, and as a result, it is possible to sufficiently improve the assembly efficiency. Also, according to the above coil component, by equipping the first bobbin member with the support that is formed so as to be capable of surrounding and supporting lower portions of the respective joints of the coil members, even if chips and burrs are produced by screwing a screw into the first joining hole when joining the first joint of the first coil member and the second joint of the second coil member, it is possible to reliably catch the chips and burrs using the support. This means that according to the above coil component, it is possible to reliably avoid a situation where chips and burrs fall onto electric circuits or the like on which the coil component is incorporated and cause electrical shorting.

It should be noted that the disclosure of the present invention relates to the contents of Japanese Patent Application No. 2017-126899 that was filed on Jun. 29, 2017, the entire contents of which are herein incorporated by reference.

### BRIEF DESCRIPTION OF THE DRAWINGS

These and other objects and features of the present invention will be explained in more detail below with reference to the attached drawings, wherein:

FIG. 1 is a perspective view of a coil component 1 or 101;

FIG. 2 is an exploded perspective view of a coil component 1;

FIG. 3 is a perspective view of a first bobbin member 2a;

FIG. 4 is a plan view of the first bobbin member 2a;

FIG. 5 is a perspective view of a second bobbin member 2b;

FIG. 6 is a plan view of the second bobbin member 2b;

FIG. 7 is a perspective view of a first coil member 3a;

FIG. 8 is a plan view of the first coil member 3a;

FIG. 9 is a perspective view of a second coil member 3b;

FIG. 10 is a plan view of the second coil member 3b;

FIG. 11 is a first diagram useful in explaining a method of assembling the coil component 1;

FIG. 12 is a second diagram useful in explaining a method of assembling the coil component 1;

FIG. 13 is a third diagram useful in explaining a method of assembling the coil component 1;

FIG. 14 is a fourth diagram useful in explaining a method of assembling the coil component 1;

FIG. 15 is a fifth diagram useful in explaining a method of assembling the coil component 1;

FIG. 16 is a sixth diagram useful in explaining a method of assembling the coil component 1;

FIG. 17 is a seventh diagram useful in explaining a method of assembling the coil component 1;

FIG. 18 is an eighth diagram useful in explaining a method of assembling the coil component 1; and

FIG. 19 is a cross-sectional view of the coil component 101 that has been cut on a plane X in FIG. 1.

### DESCRIPTION OF THE PREFERRED EMBODIMENTS

Preferred embodiments of a coil component will now be described with reference to the attached drawings.

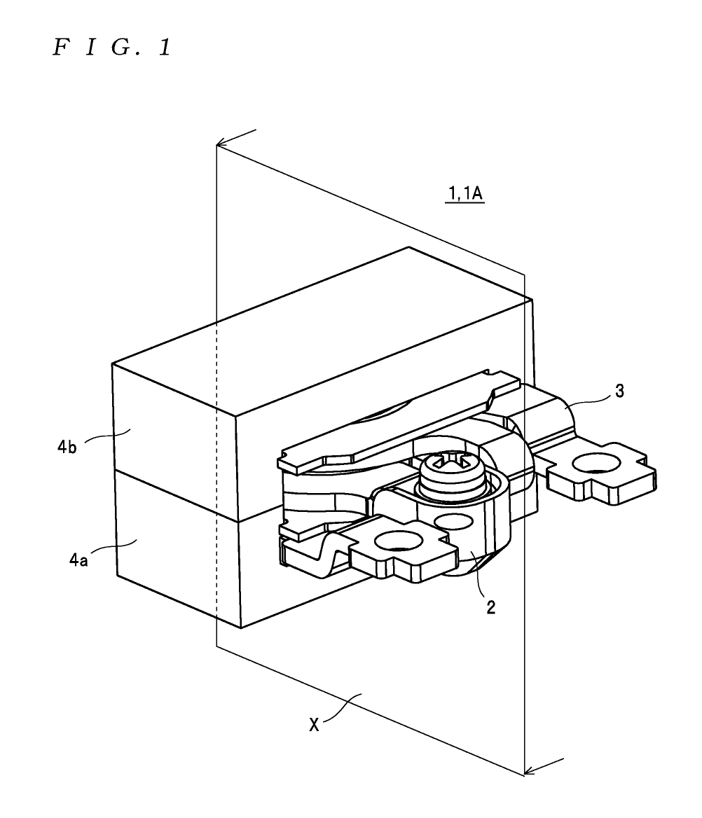

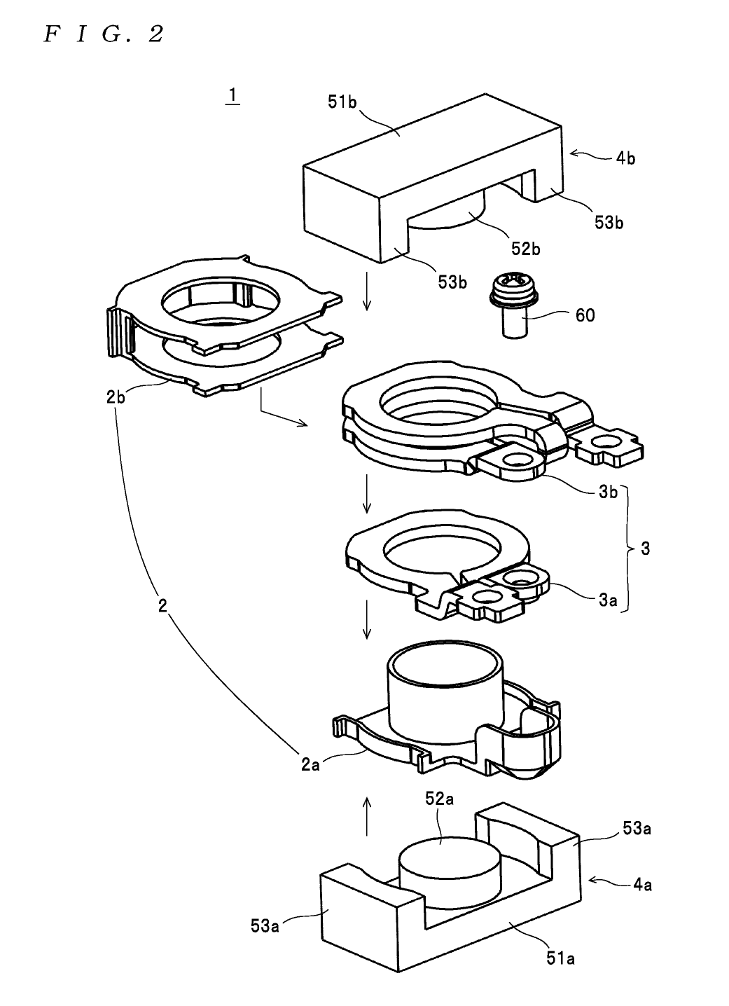

First, the configuration of a coil component 1 depicted in FIG. 1 will be described as an example of a coil component. The coil component 1 is an electrical component to be used in a switching power supply, for example, and as depicted in FIG. 1 and FIG. 2, includes a bobbin 2, a coil 3, and cores 4a and 4b. Note that a component composed of the bobbin 2 and the coil 3 without the cores 4a and 4b is also included in the intended meaning of the expression “coil component” used here.

As depicted in FIG. 2, the bobbin 2 includes a first bobbin member 2a (one example of a “first bobbin member” for the present invention) and a second bobbin member 2b (one example of a “second bobbin member” for the present invention).

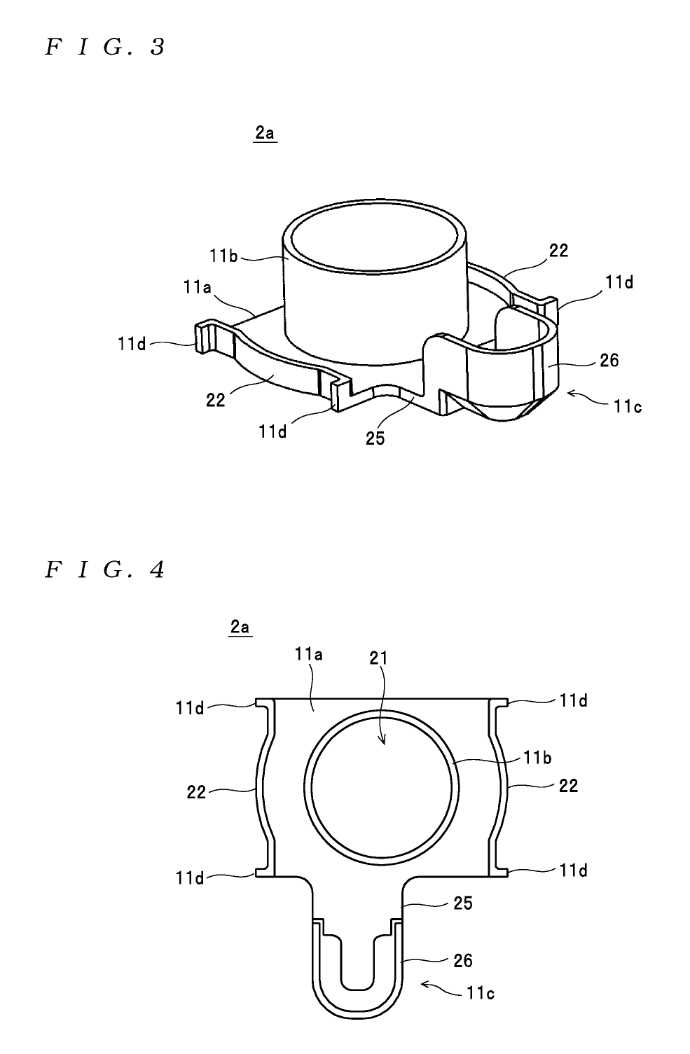

As depicted in FIGS. 3 and 4, the first bobbin member 2a includes a base plate 11a, a barrel 11b, a support 11c, and four projecting portions 11d, which are integrally formed using a non-conductive material (such as resin).

As depicted in FIG. 4, the base plate 11a is formed in a plate-like shape that has a circular opening 21 (or “first opening”) in a central portion thereof. As depicted in FIGS. 3 and 4, walls 22 are erected along two facing edges of the base plate 11a. The barrel 11b is formed in a barrel shape and is erected on the base plate 11a so as to connect to the opening 21 of the base plate 11a.

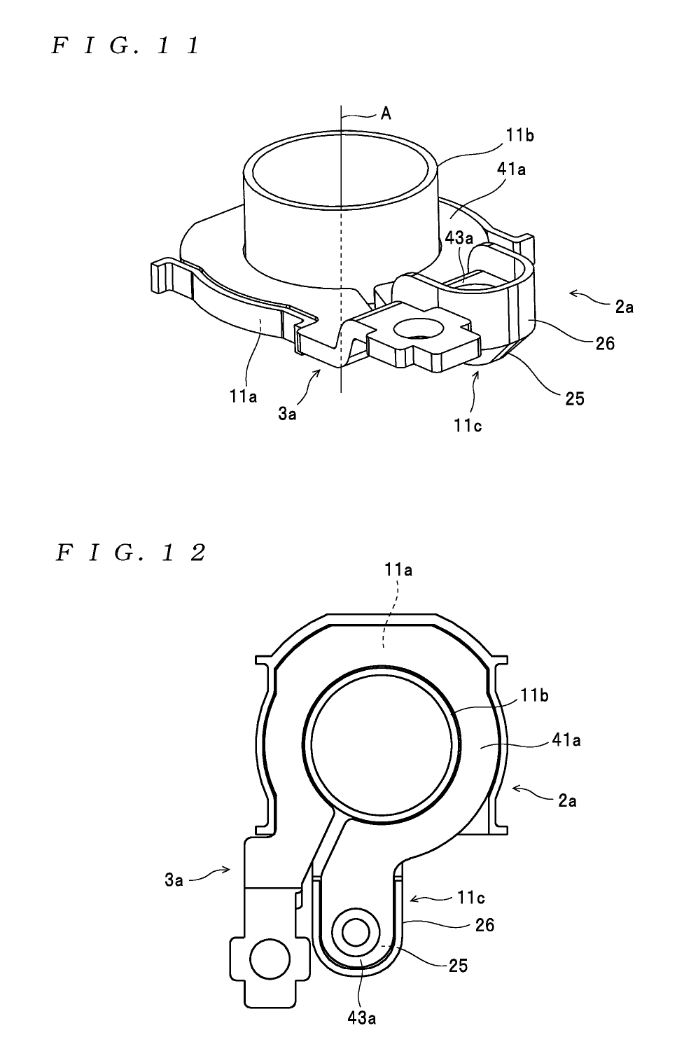

As depicted in FIGS. 3 and 4, the support 11c includes a base 25 that extends from the base plate 11a on the same plane as the base plate 11a and a wall 26 that is U-shaped for example when looking from above and is erected on the base 25. The support 11c surrounds and supports lower portions of a joining portion 43a (one example of a “first joint” for the present invention) of a first coil member 3a, described later, and a joining portion 43b (one example of a “second joint” for the present invention) of the second coil member 3b that construct the coil 3. More specifically, the support 11c supports a lower surface of the connecting portion 43a and a side surface of the connecting portion 43b (see FIGS. 11 and 14). The support 11c also functions as a first positioner that positions the first coil member 3a and a second positioner that positions the second coil member 3b. Also, as depicted in FIGS. 11 and 14, the support 11c is formed at a position set so that the joining portions 43a and 43b fit and are positioned inside the wall 26 when the first coil member 3a and the second coil member 3b are moved along a center axis A of the barrel 11b from a front end of the barrel 11b toward the base plate 11a. Note that the shape of the support 11c is not limited to the shape described above and it is possible to use various shapes, such as a shape where the wall is U shaped when viewed from above and a shape where the support 11c as a whole is hemispherical.

As depicted in FIGS. 3 and 4, the projecting portions 11d are formed so as to protrude from both ends of the walls 22 erected on the base plate 11a. The projecting portions 11d function as third positioners that position the core 4a.

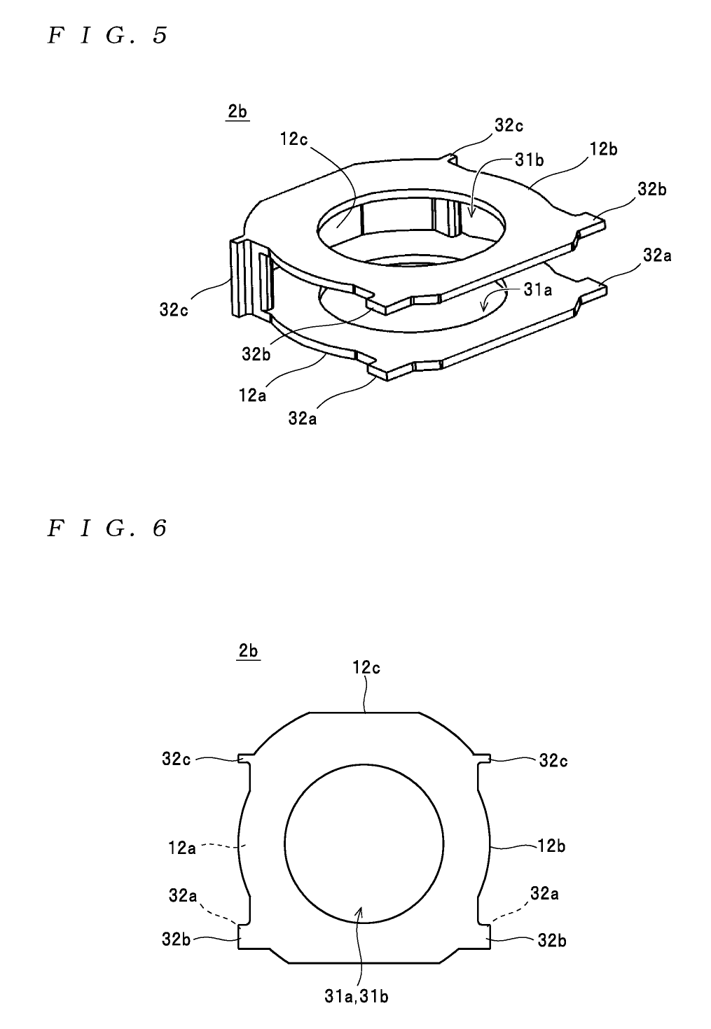

As depicted in FIGS. 5 and 6, the second bobbin member 2b includes insulating plates 12a and 12b and a side wall 12c, which are integrally formed of a non-conductive material (such as resin) to form a U shape when looking from the side.

The insulating plate 12a corresponds to a “first insulator” for the present invention, and as depicted in FIGS. 5 and 6, is formed in a plate-like shape with an opening 31a (or “second opening” for the present invention) in a central portion thereof. Two projecting portions 32a are formed on the insulating plate 12a.

The insulating plate 12b corresponds to a “second insulator” for the present invention, and as depicted in FIGS. 5 and 6, is formed in a plate-like shape with an opening 31b (or “third opening” for the present invention) in a central portion thereof. Two projecting portions 32b are formed on the insulating plate 12b.

As depicted in FIGS. 5 and 6, the side wall 12c is formed in a plate-like shape and connects parts of the edges of the insulating plates 12a and 12b that face each other at a distance. Two projecting portions 32c are formed on the side wall 12c. The projecting portions 32a, 32b, and 32c described above function as “fourth positioner” that position the core 4b.

The second bobbin member 2b is disposed above the first coil member 3a with the barrel 11b of the first bobbin member 2a inserted through the openings 31a and 31b of the insulating plates 12a and 12b (see FIG. 14) in a state where the second coil member 3b of the coil 3, described later, is sandwiched by the second bobbin member 2b. The insulating plate 12a functions so as to insulate the first coil member 3a and the second coil member 3b from each other and the insulating plate 12b functions so as to insulate the second coil member 3b and the core 4b from each other.

As depicted in FIG. 2, the coil 3 is composed of the first coil member 3a (one example of the “first coil member” for the present invention) and the second coil member 3b (one example of the “second coil member” for the present invention) and winds around the bobbin 2.

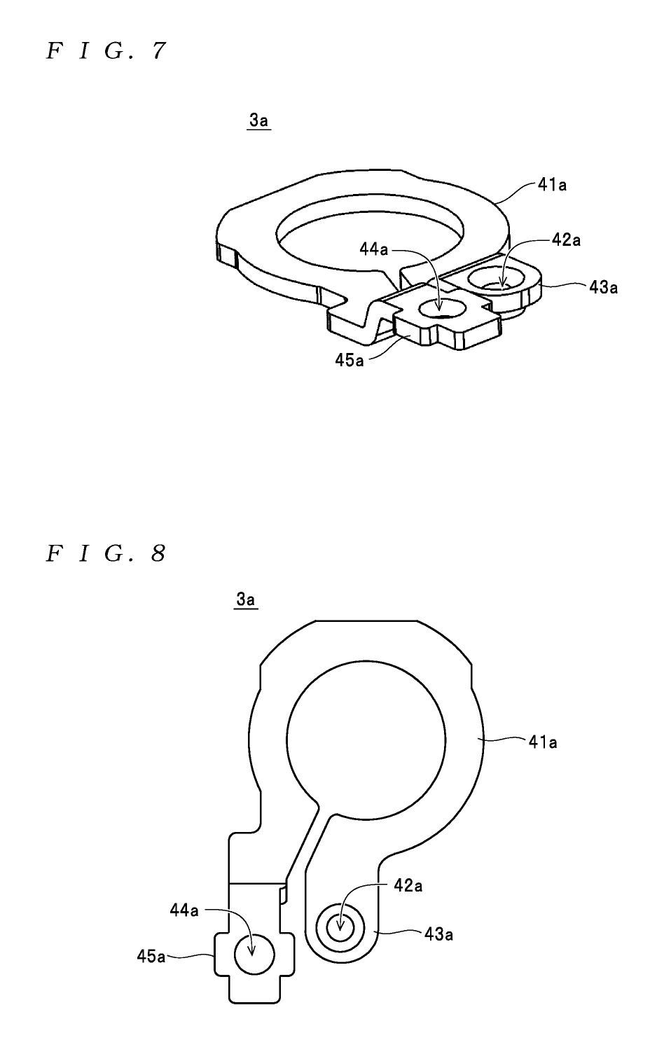

As depicted in FIGS. 7 and 8, the first coil member 3a includes a main body 41a (one example of a “first main body” for the present invention) that is substantially arc-shaped (a shape where a slit is provided in part of a ring), a joining portion 43a provided at one end of the main body 41a (the right end in FIGS. 7 and 8), and a connector 45a provided on the other end of the main body 41a (the left end in FIGS. 7 and 8), and is formed of a conductive material (for example, copper). A screw hole 42a (one example of a “first joining hole” for the present invention) into which a screw 60 depicted in FIG. 2 is screwed is formed in the joining portion 43a. An insertion through-hole 44a through which a screw, not illustrated, used when connecting to an external connected object (such as a connection terminal) passes is formed in the connector 45a.

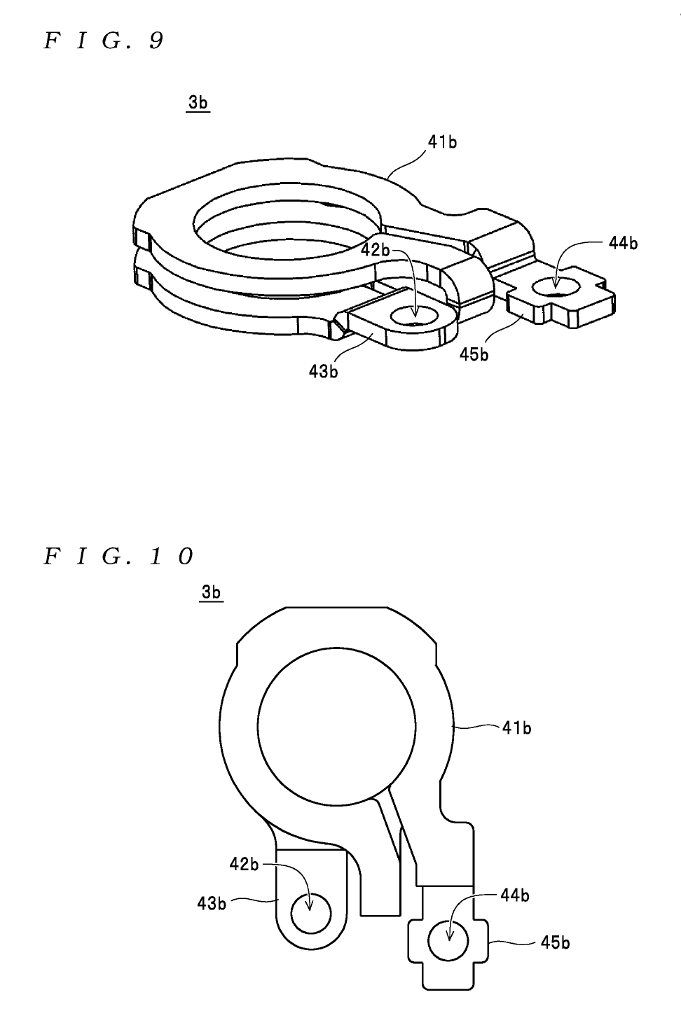

As depicted in FIGS. 9 and 10, the second coil member 3b includes a main body 41b (one example of a “second main body” for the present invention) that is spirally shaped (that is, a shape produced by ring-shaped parts that have slits and overlap each other), a joining portion 43b provided at one end of the main body 41b (the left end in FIGS. 9 and 10), and a connector 45b provided on the other end of the main body 41b (the right end in FIGS. 9 and 10), and is formed of a conductive material (for example, copper that is the same material as the first coil member 3a). An insertion through-hole 42b (one example of a “second joining hole” for the present invention) through which the screw 60 depicted in FIG. 2 can be inserted is formed in the joining portion 43b. An insertion through-hole 44b through which a screw, not illustrated, used when connecting to an external connected object (such as a connection terminal) passes is formed in the connector 45b.

The first coil member 3a and the second coil member 3b construct the spiral coil 3 (see FIG. 2) winding around the barrel 11b of the first bobbin member 2a in a state where the first coil member 3a and the second coil member 3b are electrically connected via the screw 60 that has been inserted through (i.e., screwed into) the screw hole 42a of the joining portion 43a and the insertion through-hole 42b of the connecting portion 43b (see FIG. 16).

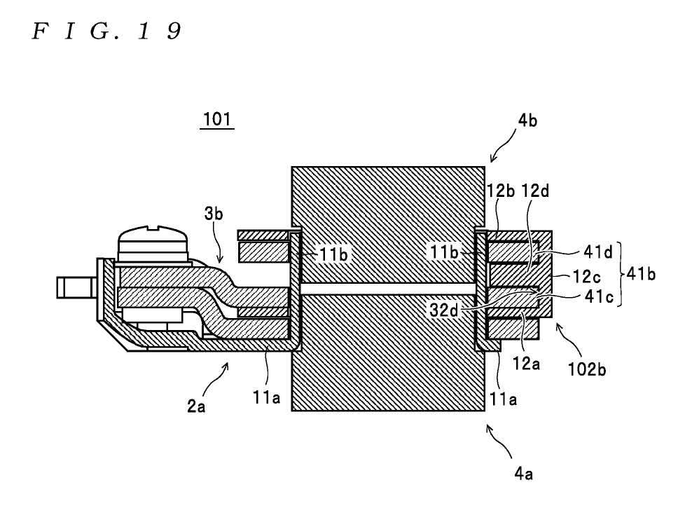

The core 4a corresponds to a “first core” for the present invention. As depicted in FIG. 2, the core 4a includes a plate-like portion 51a, a pillar-like portion 52a (one example of a “first pillar” for the present invention), and two side portions 53a, and is formed of a magnetic material. The core 4b corresponds to a “second core”. As depicted in FIG. 2, the core 4b includes a plate-like portion 51b, a pillar-like portion 52b (one example of a “second pillar” for the present invention), and two side portions 53b, and is formed in the same shape as the core 4a. With the present configuration, as depicted in FIG. 18, the core 4a is disposed on the base plate 11a side of the first bobbin member 2a in a state where the pillar-like portion 52a has been inserted into a base end side (the lower side in FIG. 18) of the barrel 11b of the first bobbin member 2a. The core 4b is disposed on the insulating plate 12b side of the second bobbin member 2b in a state where the pillar-like portion 52b has been inserted into the front end side of the barrel 11b (the upper side in FIG. 18).

Next, a method of assembling the coil component 1 will be described with reference to the drawings.

First, as depicted in FIGS. 11 and 12, the front end (the upper end in FIGS. 11 and 12) of the barrel 11b of the first bobbin member 2a that constructs the bobbin 2 is inserted through the main body 41a of the first coil member 3a that constructs the coil 3, the joining portion 43a of the first coil member 3a is then positioned above the support 11c of the first bobbin member 2a, and after this, the first coil member 3a is moved along the center axis A of the barrel 11b from the front end of the barrel 11b toward the base plate 11a of the first bobbin member 2a. When doing so, the joining portion 43a fits inside the wall 26 of the support 11c so that the first coil member 3a is disposed on the base plate 11a of the first bobbin member 2a.

With this configuration, by fitting the joining portion 43a of the first coil member 3a inside the wall 26 of the support 11c of the first bobbin member 2a, a lower portion of the joining portion 43a (i.e., the lower surface and the side surface) becomes supported in a state where the lower portion is surrounded by the base 25 and the wall 26 of the support 11c. By fitting the joining portion 43a inside the wall 26 of the support 11c, the first coil member 3a is positioned relative to the first bobbin member 2a.

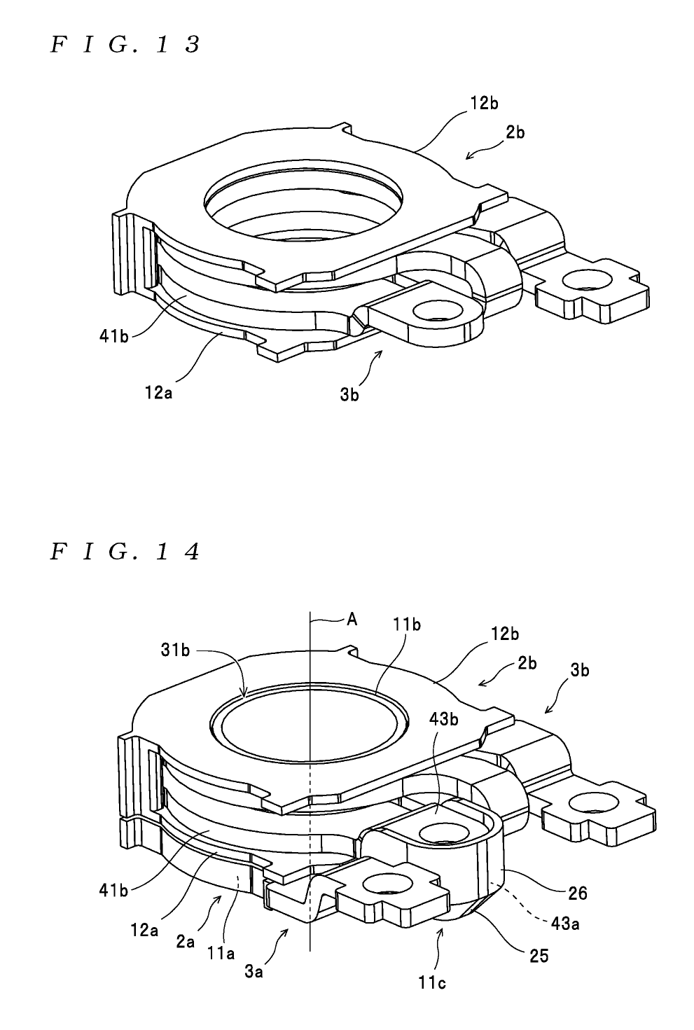

Next, as depicted in FIG. 13, the main body 41b of the second coil member 3b that constructs the coil 3 is sandwiched by the insulating plates 12a and 12b of the second bobbin member 2b that constructs the bobbin 2.

Next, as depicted in FIG. 14, the front end of the barrel 11b of the first bobbin member 2a is inserted through the opening 31a of the insulating plate 12a of the second bobbin member 2b (see FIG. 5), the main body 41b of the second coil member 3b, and the opening 31b of the insulating plate 12b of the second bobbin member 2b, the joining portion 43b of the second coil member 3b is then positioned above the support 11c of the first bobbin member 2a, and after this, the second coil member 3b is moved together with the second bobbin member 2b along the center axis A of the barrel 11b from the front end of the barrel 11b toward the base plate 11a of the first bobbin member 2a. When doing so, the joining portion 43b fits inside the wall 26 of the support 11c and the second bobbin member 2b and the second coil member 3b are disposed on the first coil member 3a.

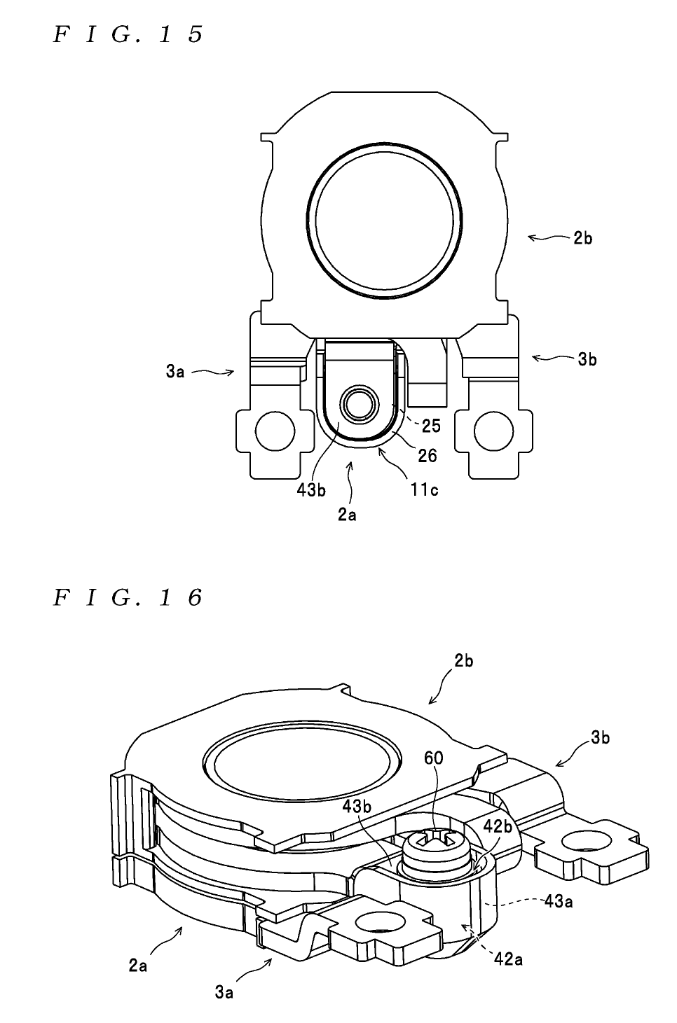

Here, as depicted in FIGS. 14 and 15, by fitting the joining portion 43b of the second coil member 3b inside the wall 26 of the support 11c of the first bobbin member 2a, the lower portion of the joining portion 43b (that is, the lower surface and the side surface) becomes supported in a state where the lower portion is surrounded by the base 25 (more accurately, by the joining portion 43a of the first coil member 3a that is supported by the base 25) and the wall 26 of the support 11c. By fitting the joining portion 43b inside the wall 26 of the support 11c, the second coil member 3b is positioned relative to the first bobbin member 2a.

In the state where the barrel 11b has been inserted through the opening 31a, the insulating plate 12a is disposed on the first coil member 3a and insulates the first coil member 3a and the second coil member 3b from each other. In the state where the barrel 11b has been inserted through the opening 31b, the insulating plate 12b is disposed on the second coil member 3b.

Next, as depicted in FIG. 16, the front end of the screw 60 is inserted through the insertion through-hole 42b formed in the joining portion 43b of the second coil member 3b and then the screw 60 is screwed into the screw hole 42a formed in the joining portion 43a of the first coil member 3a. By doing so, the joining portions 43a and 43b are joined and the first coil member 3a and the second coil member 3b are electrically connected.

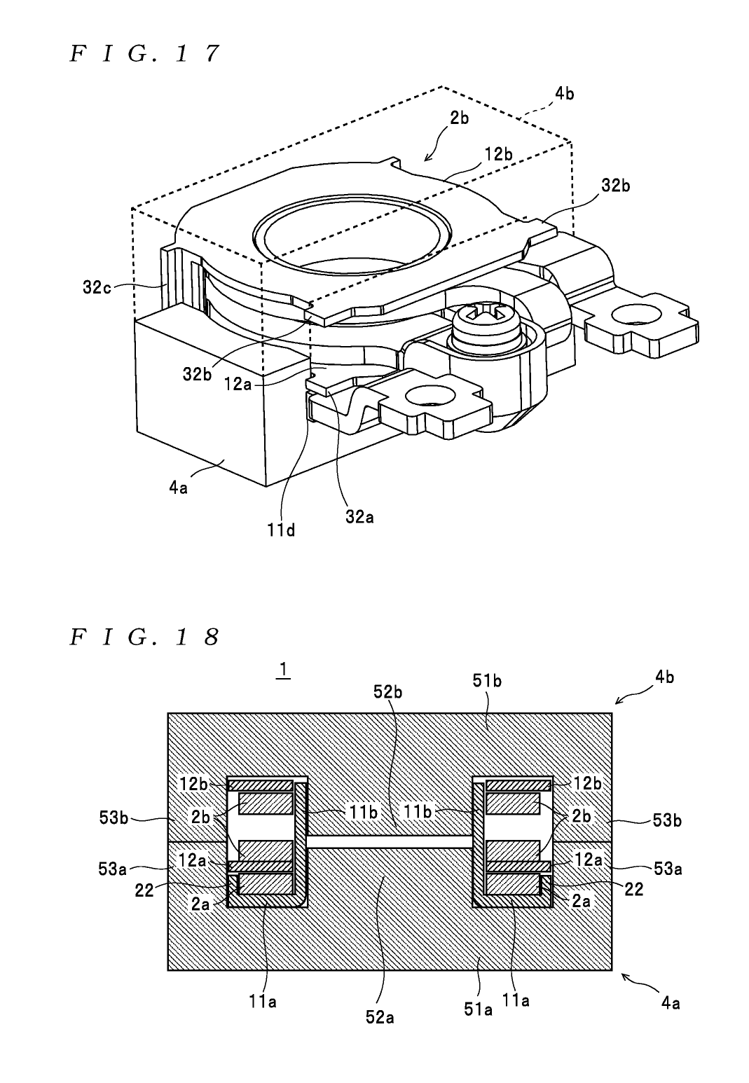

Next, as depicted by the solid lines in FIG. 17, the core 4a is attached. More specifically, as depicted in FIG. 18, the pillar-like portion 52a of the core 4a is inserted from the base end side (the lower side in FIG. 18) of the barrel 11b of the first bobbin member 2a and the side portions 53a of the core 4a are fitted outside the walls 22 of the base plate 11a of the first bobbin member 2a. At this time, as depicted in FIG. 17, ends of the side portions 53a of the core 4a come into contact with the projecting portions 11d formed on the walls 22 so that the first coil member 3a is positioned with respect to the first bobbin member 2a. The ends of the side portions 53a of the core 4a also come into contact with the projecting portions 32a formed on the insulating plate 12a of the second bobbin member 2b and the projecting portions 32c formed on the side wall 12c of the second bobbin member 2b, and by doing so the first bobbin member 2a and the core 4a are positioned. In a state where the core 4a is attached, the base plate 11a of the first bobbin member 2a is interposed between the core 4a and the first coil member 3a, which means that the core 4a and the first coil member 3a are insulated from each other.

Next, as depicted by the broken lines in FIG. 17, the core 4b is attached. More specifically, as depicted in FIG. 18, the pillar-like portion 52b of the core 4b is inserted from the front end side (the upper side in FIG. 18) of the barrel 11b of the first bobbin member 2a and the side portions 53b of the core 4b are fitted outside the insulating plate 12b of the second bobbin member 2b. At this time, as depicted in FIG. 17, ends of the side portions 53b of the core 4b come into contact with the projecting portions 32b formed on the insulating plate 12b and the projecting portions 32c formed on the side wall 12c of the second bobbin member 2b so that the second bobbin member 2b and the core 4b are positioned. In a state where the core 4b is attached, the insulating plate 12b of the second bobbin member 2b is interposed between the core 4b and the second coil member 3b, which means that the core 4b and the second coil member 3b are insulated from each other. By performing the above processes, assembly of the coil component 1 is completed.

In this way, according to the coil component 1, by providing the support 11c on the first bobbin member 2a as a first positioner and the second positioner that are capable of positioning the coil members 3a and 3b when the coil members 3a and 3b are moved along the center axis A of the barrel 11b of the first bobbin member 2a from the front end of the barrel 11b toward the base plate 11a of the first bobbin member 2a, it is possible to position the coil members 3a and 3b relative to the first bobbin member 2a by merely moving the coil members 3a and 3b in one direction (that is, the direction from the front end of the barrel 11b toward the base plate 11a). This means that according to the coil component 1, compared to a conventional configuration that inserts the barrel of the coil bobbin into the two coil windings from different directions and positions the coil bobbin and the respective coil windings by rotating the coil windings with respect to the coil bobbin, it is possible to sufficiently simplify the assembly process. Since the assembly process is simplified, it is possible to automate the assembly using a robot, and as a result, it is possible to sufficiently improve the assembly efficiency. Also, according to the coil component 1, by equipping the first bobbin member 2a with the support 11c that is formed so as to be capable of surrounding and supporting lower portions of the joining portions 43a and 43b of the coil members 3a and 3b, even if chips and burrs are produced by screwing the screw 60 into the screw hole 42a when joining the joining portion 43a of the first coil member 3a and the joining portion 43b of the second coil member 3b, it is possible to reliably catch the chips and burrs using the support 11c. This means that according to the coil component 1, it is possible to reliably avoid a situation where chips and burrs fall onto electric circuits or the like on which the coil component 1 is incorporated and cause electrical shorting.

Also, according to the coil component 1, by constructing the second bobbin member 2b so as to include the insulating plate 12b as a second insulator disposed on the second coil member 3b, it is possible to insulate the second coil member 3b, so that even when electrical components or the like are disposed in the vicinity of the second coil member 3b when the coil component 1 is incorporated for example, it is possible to reliably prevent electrical shorting between the second coil member 3b and such electrical components and the like without having to separately attach an insulator.

Also, according to the coil component 1, parts of the respective edges of the insulating plates 12a and 12b are connected by the side wall 12c in a state where the insulating plates 12a and 12b face each other at a distance to produce an integrated structure, which makes it possible to sandwich the second coil member 3b with the insulating plates 12a and 12b. As a result, it is possible to collectively dispose the insulating plates 12a and 12b and the second coil member 3b on the first coil member 3a in a state where the second coil member 3b is sandwiched by the insulating plates 12a and 12b. Therefore, according to the coil component 1, it is possible to further improve the assembly efficiency. In addition, according to the coil component 1, since it is possible to surround (cover) the second coil member 3b using the side wall 12c, even when electrical components or the like are disposed in the vicinity of the second coil member 3b when the coil component 1 is incorporated for example, it is possible to reliably prevent electrical shorting between the second coil member 3b and such electrical components or the like without having to separately attach insulating materials.

According to the coil component 1, by having the support 11c function as the first positioner that positions the first coil member 3a and the second positioner that positions the second coil member 3b, compared to a configuration that is provided with a first positioner and a second positioner separately to the support 11c, it is possible to simplify the construction. Since it is possible to position the coil members 3a and 3b by merely supporting the joining portions 43a and 43b with the support 11c (i.e., fitting the joining portions 43a and 43b onto the support 11c), it is possible to further improve the assembly efficiency.

According to the coil component 1, by configuring the first bobbin member 2a so as to include the projecting portions 11d as third positioners that position the core 4a, it is possible to position the core 4a by merely attaching the core 4a to the first bobbin member 2a, which means that it is possible to sufficiently improve the assembly efficiency of the coil component 1 that includes the cores 4a and 4b.

According to the coil component 1, by constructing the second bobbin member 2b so as to include the projecting portions 32a, 32b, and 32c as fourth positioners that position the core 4b, it is possible to position the core 4b by merely attaching the core 4b to the second bobbin member 2b, which makes it possible to further improve the assembly efficiency of the coil component 1 that includes the cores 4a and 4b. Also according to the coil component 1, it is possible to keep both the cores 4a and 4b in the positioned state using the projecting portions 11d as the third positioners and the projecting portions 32a, 32b, and 32c as the fourth positioners. This means that according to the coil component 1, there are many variations to the assembly method, such as an assembly method where coil components 1 are stocked in advance in a state where the cores 4a and 4b have been attached to the bobbin 2 (a sub-assembly stage) and the stocked coil components 1 are disposed on electrical circuits or the like and an assembly method that attaches the cores 4a and 4b to the bobbin 2 immediately before the coil component 1 is disposed on electrical circuits or the like. By selecting an appropriate assembly method with consideration to other processes, it is possible to further improve the assembly efficiency. Also, according to the coil component 1, since it is possible to position both the cores 4a and 4b, it is possible to omit a process that prevents displacement by fixing the cores 4a and 4b using adhesive tape or the like which is necessary for configurations that lack a function that positions both of the cores 4a and 4b. As a result, it is possible to further improve the assembly efficiency of the coil component 1 that includes the cores 4a and 4b.

A coil component according to the present invention is not limited to the configuration of the coil component 1 described above. As one example, it is also possible to apply the present invention to a coil component 101 depicted in FIG. 19. Note that in the following description, component elements that are the same as the component elements of the coil component 1 described above have been assigned the same reference numerals and duplicated description thereof is omitted. In place of the second bobbin member 2b of the coil component 1 described above, the coil component 101 includes a second bobbin member 102b. As depicted in FIG. 19, the second bobbin member 102b includes a non-conductive holding portion 12d formed in a flange shape (plate shape) that protrudes from an inner circumferential surface 32d of the side wall 12c. Here, as depicted in FIG. 19, the holding portion 12d is inserted between two ring-shaped portions 41c and 41d that compose a main body 41b of the second coil member 3b and face each other at a distance, and functions so as to hold the ring-shaped portions 41c and 41d in the separated state. According to the coil component 101, by configuring the second bobbin member 102b so as to include the holding portion 12d, it is possible to reliably hold the ring-shaped portions 41c and 41d in the separated state, which means that it is possible to reliably prevent a situation where the electrical properties change due to the ring-shaped portions 41c and 41d coming into contact.

Also, although an example configuration where the fourth positioners (i.e., the projecting portions 32a, 32b, and 32c) provided on the second bobbin member 2b position the core 4b has been described, it is also possible to apply the present invention to a configuration where the projecting portions 11d as the third positioner function so as to position both the cores 4a and 4b. With this configuration, by extending the projecting portions 11d upward, it becomes possible, when attaching the core 4b, for the ends of the side portions 53a of the core 4b to contact the projecting portions 11d and thereby position the core 4b. Since this configuration makes the fourth positioning portions of the second bobbin member 2b unnecessary, it is possible to simplify the configuration of the second bobbin member 2b to a corresponding degree.

Although an example where the coil 3 is constructed of the arc-shaped first coil member 3a and the spiral-shaped second coil member 3b has been described above, it is also possible to apply the present invention to a coil 3 that includes a spiral-shaped first coil member 3a and an arc-shaped second coil member 3b, to a coil 3 where both the coil members 3a and 3b are arc-shaped, and to a coil 3 where both the coil members 3a and 3b are spiral-shaped.

Although an example where the support 11c functions as both the first positioner and the second positioner has been described above, it is also possible to apply the present invention to a configuration where the first positioner and the second positioner are provided separately to the support 11c. When doing so, it is possible to have a single positioner function as the first positioner and the second positioner, or the first positioner and the second positioner may be separate.

Although an example where the insulating plates 12a and 12b are integrated by being connected by the side wall 12c has been described above, the insulating plates 12a and 12b may be separately constructed. It is also possible to construct the second bobbin member 2b of only the insulating plate 12a without the insulating plate 12b being provided.

Moreover, the invention encompasses any possible combination of some or all of the various embodiments and the modification examples described herein and incorporated herein.

It is possible to achieve at least the following configurations from the above-described example embodiments and the modification examples of the disclosure.

(1) A coil component comprising:

a non-conductive bobbin; and

a coil that winds around the bobbin,

wherein the coil includes:

a first coil member with a first main body, which is formed in one of an arc shape and a spiral shape, and a first joint, which is provided at one end of the first main body and in which a first joining hole is formed; and

a second coil member with a second main body, which is formed in one of an arc shape and a spiral shape, and a second joint, which is provided at one end of the second main body and in which a second joining hole is formed,

wherein the second coil member is electrically connected to the first coil member via a screw that is inserted through the first and second joining holes of the first and second joints,

the bobbin includes a first bobbin member and a second bobbin member,

the first bobbin member includes: a base plate that has a first opening formed in a central portion thereof; a barrel that is erected on the base plate so as to connect to the first opening; a first positioner that positions the first coil member when the first coil member is moved along a center axis of the barrel from a front end of the barrel toward the base plate; a second positioner that positions the second coil member when the second coil member is moved along the center axis from the front end of the barrel toward the base plate; and a support that is provided on the base plate and is formed so as to surround and support lower portions of the first and second joints of the first and second coil members,

the second bobbin member includes a first insulator that is plate-shaped, has a second opening formed in a central portion thereof, and is disposed between the first and second coil members to insulate the first and second coil members from each other,

the first coil member is positioned by the first positioner in a state where the barrel is inserted through the first main body and the first coil member is disposed on the base plate, and the first joint is supported by the support,

the first insulator is disposed on the first coil member in a state where the barrel has been inserted through the second opening, and

the second coil member is positioned by the second positioner in a state where the barrel is inserted through the second main body and the second coil member is disposed on the first insulator, and the second joint is supported by the support.

(2) The coil component according to (1),

wherein the second bobbin member includes a second insulator that is plate-shaped and has a third opening in a central portion thereof, and

the second insulator is disposed on the second coil member in a state where the barrel has been inserted through the third opening.

(3) The coil component according to (2),

wherein the first and second insulators face each other at a distance and are integrated due to parts of edges of the first and second insulators being connected by a side wall.

(4) The coil component according to (3),

wherein the second main body is formed in a spiral shape and has two rings that face each other at a distance, and

the second bobbin member includes a non-conductive holder that is formed in a flange shape that protrudes from an inner surface of the side wall, is inserted between the rings, and holds the rings in a separated state.

(5) The coil component according to any of (1) to (4),

wherein the support functions as the first positioner and the second positioner.

(6) The coil component according to any of (1) to (5), further comprising:

a first core that has a first pillar inserted into a base end side of the barrel; and

a second core that has a second pillar inserted into the front end side of the barrel,

wherein the first bobbin member includes a third positioner that positions the first core.

(7) The coil component according to (6),

wherein the second bobbin member includes a fourth positioner that positions the second core.

(8) The coil component according to (6),

wherein the third positioner positions the second core.

What is claimed is:

1. A coil component comprising:
a non-conductive bobbin; and
a coil that winds around the bobbin,
wherein the coil includes:
a first coil member with a first main body, which is formed in one of an arc shape and a spiral shape, and a first joint, which is provided at one end of the first main body and in which a first joining hole is formed; and
a second coil member with a second main body, which is formed in one of an arc shape and a spiral shape, and a second joint, which is provided at one end of the second main body and in which a second joining hole is formed,
wherein the second coil member is electrically connected to the first coil member via a screw that is inserted through the first and second joining holes of the first and second joints,
the bobbin includes a first bobbin member and a second bobbin member,
the first bobbin member includes: a base plate that has a first opening formed in a central portion thereof; a barrel that is erected on the base plate so as to connect to the first opening; a first positioner that positions the first coil member when the first coil member is moved along a center axis of the barrel from a front end of the barrel toward the base plate; a second positioner that positions the second coil member when the second coil member is moved along the center axis from the front end of the barrel toward the base plate; and a support that is provided on the base plate and is formed so as to surround and support lower portions of the first and second joints of the first and second coil members,
the second bobbin member includes a first insulator that is plate-shaped, has a second opening formed in a central portion thereof, and is disposed between the first and second coil members to insulate the first and second coil members from each other,
the first coil member is positioned by the first positioner in a state where the barrel is inserted through the first main body and the first coil member is disposed on the base plate, and the first joint is supported by the support,
the first insulator is disposed on the first coil member in a state where the barrel has been inserted through the second opening, and
the second coil member is positioned by the second positioner in a state where the barrel is inserted through the second main body and the second coil member is disposed on the first insulator, and the second joint is supported by the support.

2. The coil component according to claim 1,
wherein the second bobbin member includes a second insulator that is plate-shaped and has a third opening in a central portion thereof, and
the second insulator is disposed on the second coil member in a state where the barrel has been inserted through the third opening.

3. The coil component according to claim 2,
wherein the first and second insulators face each other at a distance and are integrated due to parts of edges of the first and second insulators being connected by a side wall.

4. The coil component according to claim 3,
wherein the second main body is formed in a spiral shape and has two rings that face each other at a distance, and
the second bobbin member includes a non-conductive holder that is formed in a flange shape that protrudes from an inner surface of the side wall, is inserted between the rings, and holds the rings in a separated state.

5. The coil component according to claim 1,
wherein the support functions as the first positioner and the second positioner.

6. The coil component according to claim 2,
wherein the support functions as the first positioner and the second positioner.

7. The coil component according to claim 3,
wherein the support functions as the first positioner and the second positioner.

8. The coil component according to claim 4,
wherein the support functions as the first positioner and the second positioner.

9. The coil component according to claim 1, further comprising:
a first core that has a first pillar inserted into a base end side of the barrel; and
a second core that has a second pillar inserted into the front end side of the barrel,
wherein the first bobbin member includes a third positioner that positions the first core.

10. The coil component according to claim 2, further comprising:
a first core that has a first pillar inserted into a base end side of the barrel; and
a second core that has a second pillar inserted into the front end side of the barrel,
wherein the first bobbin member includes a third positioner that positions the first core.

11. The coil component according to claim 3, further comprising:
a first core that has a first pillar inserted into a base end side of the barrel; and
a second core that has a second pillar inserted into the front end side of the barrel,
wherein the first bobbin member includes a third positioner that positions the first core.

12. The coil component according to claim 4, further comprising:
a first core that has a first pillar inserted into a base end side of the barrel; and
a second core that has a second pillar inserted into the front end side of the barrel,
wherein the first bobbin member includes a third positioner that positions the first core.

13. The coil component according to claim 5, further comprising:
a first core that has a first pillar inserted into a base end side of the barrel; and
a second core that has a second pillar inserted into the front end side of the barrel,
wherein the first bobbin member includes a third positioner that positions the first core.

14. The coil component according to claim 6, further comprising:
a first core that has a first pillar inserted into a base end side of the barrel; and
a second core that has a second pillar inserted into the front end side of the barrel,
wherein the first bobbin member includes a third positioner that positions the first core.

15. The coil component according to claim 7, further comprising:
a first core that has a first pillar inserted into a base end side of the barrel; and
a second core that has a second pillar inserted into the front end side of the barrel,
wherein the first bobbin member includes a third positioner that positions the first core.

16. The coil component according to claim 8, further comprising:
a first core that has a first pillar inserted into a base end side of the barrel; and
a second core that has a second pillar inserted into the front end side of the barrel,
wherein the first bobbin member includes a third positioner that positions the first core.

17. The coil component according to claim 9,
wherein the second bobbin member includes a fourth positioner that positions the second core.

18. The coil component according to claim 10,
wherein the second bobbin member includes a fourth positioner that positions the second core.

19. The coil component according to claim 9,
wherein the third positioner positions the second core.

20. The coil component according to claim 10,
wherein the third positioner positions the second core.
